(19) United States
(12) Patent Application Publication
(10) Pub. No.: US 2004/0232764 A1
(43) Pub. Date: Nov. 25, 2004

(54) Method for improving the regulation behavior of a slip control system

(76) Inventors: Schahrad Schafiyha, Frankfurt (DE); Henning Raulfs, Bad Homburg (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/486,071

(22) PCT Filed: Aug. 7, 2002
(86) PCT No.: PCT/EP02/08815

(30) Foreign Application Priority Data
Aug. 10, 2001 (DE) 101 38 299.5
Jul. 22, 2002 (DE) 102 33 324.6

(51) Int. Cl. B60T 8/24; B60T 8/34

(52) U.S. Cl. 303/139; 303/113.2

(57) ABSTRACT

A method for improving the control behavior of a system for traction slip control by brake intervention (BASR), wherein a pressure value or nominal pressure referred to as a filling pulse is predetermined upon the entry into a traction slip control operation, the nominal pressure (EPₙₒₘ) is determined on the basis of a PD controller according to the relation

EPₙₒₘ₁=EP_{Base}+k_{P1}*λ_{F}+k_{D1}*\dot{λ}_{F}

to determine the filling pulse and/or as a reference input for the control of the wheel brake pressure during a traction slip control operation, wherein

EPₙₒₘ—requested nominal pressure

EP_{Base}—invariable base portion

λ_{F}—filtered wheel slip

\dot{λ}_{F}—filtered wheel slip acceleration

k_{P1}—proportional amplification factor

k_{D1}—differential amplification factor.

### TECHNICAL FIELD

The present invention generally relates to vehicle brake systems and more particularly relates to a method for improving the control behavior of a system for traction slip control by brake intervention.

### BACKGROUND OF THE INVENTION

A predetermined slip threshold defined by the controller is adjusted in prior art traction slip control systems by means of predeterminable pressures or brake forces at individual wheel brakes and by means of intervention into the engine management of the driving engine. Brake control is executed by means of a preset pressure value adjusted by a pressure controller. The pressure controller performs its function on the basis of a deviation between the requested nominal pressure EP (Estimated Pressure) and the wheel pressure MP (Model Pressure) that is either measured by means of pressure sensors or determined in approximation by reproducing a pressure model. The deviation between nominal pressure value and actual pressure value determines the actuation of the delivery pump and the corresponding valves. High-pressure dynamics (quick change in the wheel brake pressure) is given with maximum actuation of the hydraulic pump, slower pressure variations are achieved by pulsewise actuation of the pump. This applies to brake systems without a high pressure accumulator, i.e. for brake systems, wherein the pressure fluid pump must be activated upon pressure requirement.

The preset pressure value upon entry into brake control is referred to as ‘filling pulse’. This designation originates from the known provision in conventional brake control systems to displace pressure fluid volume from an accumulator reservoir (master cylinder) into the wheel brakes at the commencement of a braking operation by actuating the pump and the valves. The filling pulse is used to apply the brake linings and is controlled by an empirically determined preset pressure value or nominal pressure. The preset pressure has a constant pressure value and is initialized in dependence on the driving situation, the wheel rotational behavior, or slip. After termination of the filling pulse, the operating point is determined by a pulse train, depending on the wheel rotational behavior or slip.

In brake systems with a high pressure accumulator for the pressure supply of the brake system, the filling pulse or nominal pressure is used as a reference input for proportioning the brake pressure in the controlled wheels.

### BRIEF SUMMARY OF THE INVENTION

An object of the present invention is to develop a method for improving the control behavior of a traction slip control system allowing to adjust a ‘filling pulse’ or nominal pressure adapted to the respective situation already upon the entry into traction slip control. The objective is to early counteract loss in traction by a filling pulse, which rather precisely conforms to requirements and is oriented to the wheel slip behavior.

This object is achieved by a method of the type mentioned hereinabove, the special feature of which involving that a nominal pressure is determined on the basis of a PD controller according to the relation

EPₙₒₘ₁=EP_{Base}+k_{P1}*λ_{F}+k_{D1}*\dot{λ}_{F}

to determine or proportion the filling pulse or nominal pressure or as a reference input for the control of the wheel brake pressure during a traction slip control operation. In this equation,

EPₙₒₘ—requested nominal pressure

EP_{Base}—invariable base portion

λ_{F}—the filtered wheel slip

\dot{λ}_{F}—the filtered wheel slip acceleration

k_{P1}—a proportional amplification factor

k_{D1}—a differential amplification factor.

The method of the invention is based on the reflection that the above-mentioned PD approach permits continuously and adaptively define the filling pulse and the reference input, with the result that an accurate pressure operating point is available already upon entry into traction slip control.

According to a first embodiment of the invention, which is intended for a brake system with a pressure fluid pump that is activated when brake pressure is required, that means for brake systems without a high pressure accumulator, the nominal pressure is evaluated to adjust the pressure controller dynamics. As this occurs, the dynamics of pressure supply is varied in dependence on the difference between the nominal pressure and the actual pressure in the wheel brake or model pressure measured or determined in approximation, and is adapted to the respective situation.

Finally, according to a second embodiment of the invention, the difference of the deviation, i.e. the difference between the nominal pressure and the model pressure, is produced and evaluated, and the filling pulse is terminated when the model pressure exceeds a predetermined pressure threshold that is produced according to the relation

MPₙₒₘ=MP_{Base}+k_{P2}*λ_{F}+k_{D2}*\dot{λ}_{F}

wherein

MPₙₒₘ—requested nominal pressure

MP_{Base}—invariable base portion

λ_{F}—filtered wheel slip

\dot{λ}_{F}—filtered wheel slip acceleration

k_{P2}—proportional amplification factor

k_{D2}—differential amplification factor.

### BRIEF DESCRIPTION OF THE DRAWINGS

FIG. 1 is a schematic partial view of components or function blocks of a control system for implementing the method of the invention.

FIG. 2 is a diagram for explaining the operations when the invention is implemented in a brake system without high pressure accumulator.

FIG. 3 is a diagram, in the same illustration as FIG. 2, for explaining the operations in a brake system with a high pressure accumulator.

### DETAILED DESCRIPTION OF THE PREFERRED EMBODIMENTS

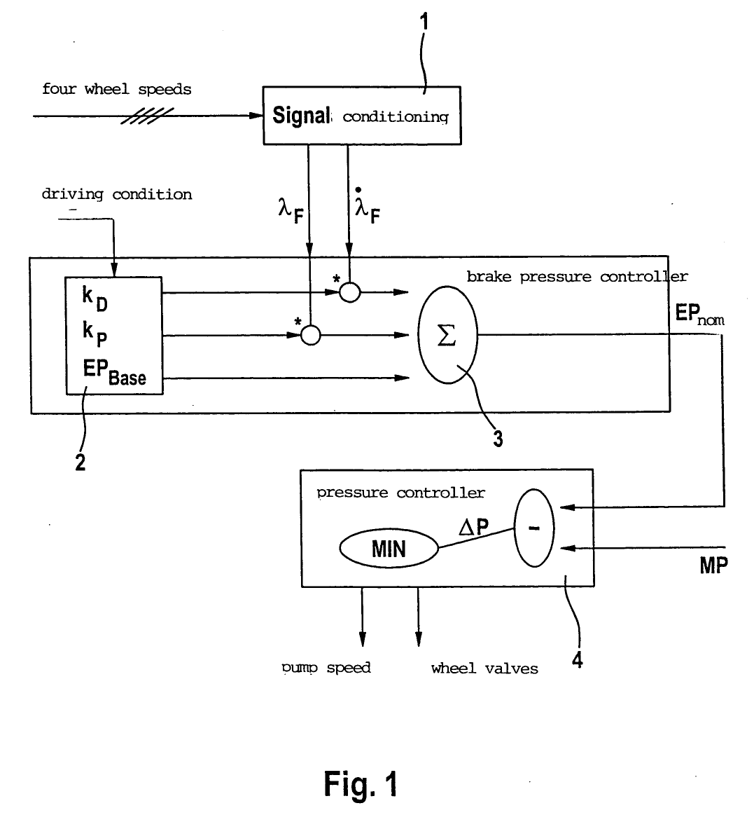

The circuit shown in FIG. 1 only in part and only symbolically is used to operate a traction slip control system wherein the brake pressure is generated by means of a hydraulic motor-and-pump assembly and conducted to the wheel brakes by way of brake pressure control valves. As is known, a model pressure can be calculated by monitoring the switching times of the valves, the pump operating times, etc., wherein model pressure indicates the actual pressure in the respective wheel brake in approximation.

According to FIG. 1, signals (‘four wheel signals’) obtained in a known fashion by means of wheel sensors and indicative of the rotational behavior of the individual vehicle wheels are evaluated in a signal-conditioning unit 1. Among others, data about the filtered wheel slip λ_{F} and about the filtered wheel slip acceleration \dot{λ}_{F} are derived from the wheel rotational behavior. These quantities are multiplied with amplification factors k_{P1} and k_{D1} produced or memorized in a switching block 2 and evaluated in an adder 3 according to the relation

EPₙₒₘ₁=EP_{Base}+k_{P1}*λ_{F}+k_{D1}*\dot{λ}_{F}

in consideration of a base portion EP_{Base}. This way, a nominal pressure EPₙₒₘ₁ is determined which is further processed in a pressure controller 4 after a comparison with a wheel pressure approximation value or model pressure MP—the difference is produced—which is measured or, as in this case, determined by producing a model. Pressure controller 4 generates actuating signals for the pressure fluid pump (‘pump speed’) of the system and for the brake pressure control valves (‘valves’). The dynamics of the traction slip control system is influenced by the actuation of the pump (permanent signal or pulses).

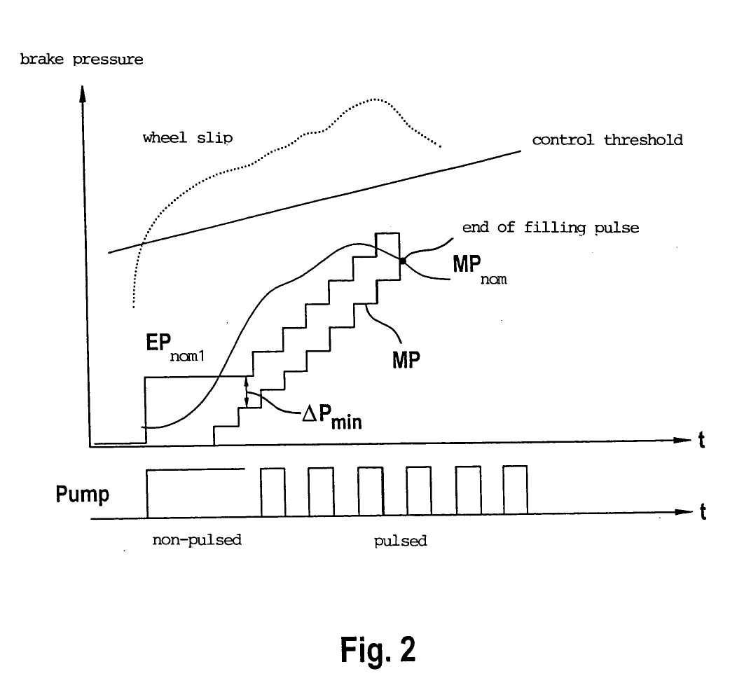

In hydraulic brake systems with delay times that must not be disregarded (these are systems wherein the pressure required for traction slip limitation is generated by actuation of a pump as soon as it is needed), the preset pressure value serves to adjust the pressure controller dynamics. The operations in a brake system of this type managing without a high pressure accumulator are illustrated in FIG. 2. The pressure controller adjusts the dynamics of the delivery pump and, thus, the comfort by way of the difference of the deviation ΔP=nominal pressure (EP)−model pressure (MP). When insignificant deviations prevail, the pump is no more fully actuated and passes over into clocked operation. When the model pressure has reached a hysteresis ΔPₘᵢₙ or minimum difference value in relation to the nominal pressure that is typical of a certain brake system, this hysteresis is applied to the preset pressure value to obtain a transition from the non-clocked to the clocked pressure buildup.

EPₙₒₘ=MP+ΔPₘᵢₙ if EPₙₒₘ−MP<ΔPₘᵢₙ.

The minimum volume converted to the pressure, which volume can be adjusted by the pressure controller within a controller cycle time (loop), corresponds to the hysteresis ΔPₘᵢₙ. The hysteresis mainly depends on the volume absorption of the brake caliper, i.e. on the pressure/volume characteristic curve.

The filling pulse is terminated if the model pressure (MP) exceeds a predetermined pressure threshold MPₙₒₘ. This feature is illustrated in FIG. 2. The pressure termination threshold is defined as

MPₙₒₘ=MP_{Base}+k_{P}*λ_{F}+k_{D}*\dot{λ}_{F}

MPₙₒₘ—requested nominal pressure

EP_{Base}—invariable base portion

λ_{F}—filtered wheel slip

\dot{λ}_{F}—filtered wheel slip acceleration

k_{P}—proportional amplification factor

k_{D}—differential amplification factor.

FIG. 2 represents the wheel slip, slip control threshold, the nominal pressure EPₙₒₘ₁, the model pressure MP (that means the wheel brake pressure determined by modeling), the termination threshold MPₙₒₘ and the pump actuation signals during a traction slip control operation. As soon as the wheel slip exceeds the control threshold, the pressure fluid pump is switched on. To reach a high dynamics, the pump is initially driven in a non-pulsed fashion, subsequently in a pulsed fashion. The transition to the pulsed actuation takes place as soon as the hysteresis threshold ΔPₘᵢₙ is reached or values fall below said threshold.

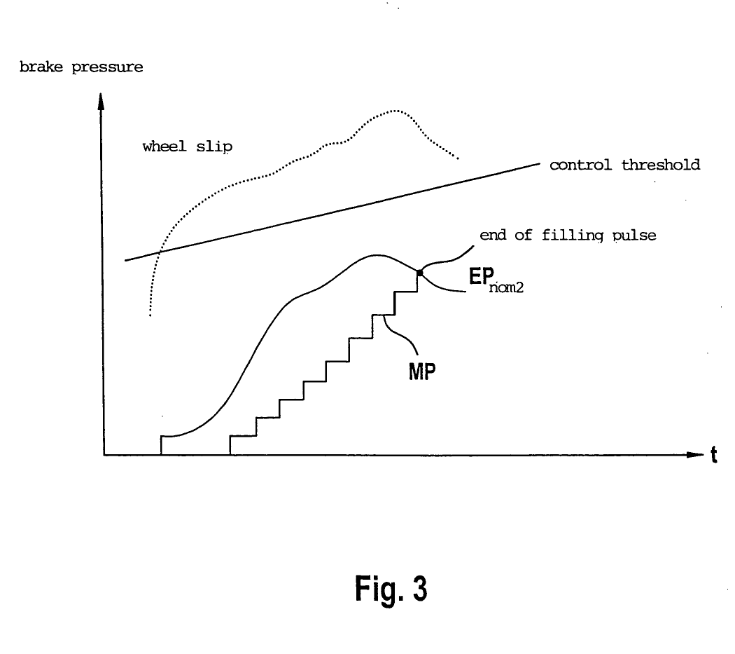

As is known, the delay times in electro-hydraulic or electro-mechanical brake systems are short when adjusting the nominal pressures because the pressure is made available by a high pressure accumulator or by means of electric energy. FIG. 3 relates to a brake system equipped with a high pressure accumulator, for example, to an electro-hydraulic brake system (EHB). It is possible in systems of this type to use the preset pressure value or nominal pressure directly as a reference input for brake control. In this arrangement, the controller parameters EP_{Base}, k_{P} and k_{D} are expediently tuned empirically in response to friction f(μ) or situation-responsively as a function of the driving condition (curve, μ-split, etc.).

Because the majority of vehicles are equipped with brake systems wherein the pressure fluid volume absorption and the brake characteristic values on the front axle and the rear axle differ from each other, with identical pressure, different brake torques will develop on the front or rear axle. Therefore, both the nominal pressure and the pressure termination threshold of the rear axle are weighted with a factor kᵣₑₐᵣ according to a favorable embodiment of the invention.

To obtain a less sensitive control behavior at higher speeds, the termination threshold is weighted as a function of speed with a factor kᵥ_{_{ref}} that is defined as follows

$${k}_{{v}_{ref}} = \frac{{v}_{limit} - {v}_{ref}}{{v}_{limit} - {v}_{thr}} if {v}_{ref} > {v}_{thr} .$$

In this relation, vₗᵢₘᵢₜ and vₜₕᵣ designate speed limit values of different magnitude, and v_{ref} usually refers to the vehicle (reference) speed.

1-6. (canceled)

7. Method for improving the control behavior of a system for traction slip control by brake intervention, including the steps of:
determining a nominal pressure valve upon the entry into a traction slip control operation,
wherein the nominal pressure (EPₙₒₘ) is determined on the basis of a PD controller according to the relation
EPₙₒₘ₁=EP_{Base}+k_{P1}*λ_{F}+k_{D1}*\dot{λ}_{F}
wherein;
EPₙₒₘ—requested nominal pressure
EP_{Base}—invariable base portion
λ_{F}—filtered wheel slip
\dot{λ}_{F}—filtered wheel slip acceleration
k_{P1}—proportional amplification factor
k_{D1}—differential amplification factor
using the nominal pressure EPₙₒₘ to determine the filing pulse or as a reference input for the control of the wheel brake pressure during a traction slip control operation.

8. Method as claimed in claim 7, further including the step of:
activating a pressure fluid pump when brake pressure is needed during a traction slip control operation, wherein the nominal pressure (EPₙₒₘ) is evaluated to adjust a dynamic of a pressure controller.

9. Method as claimed in claim 8, wherein the dynamics of the pressure controller is varied in dependence on a difference between the nominal pressure (EPₙₒₘ) and an actual pressure in the wheel brake or model pressure (MP) measured.

10. Method as claimed in claim 9, wherein a difference (ΔP) of a deviation between the nominal pressure (EPₙₒₘ) and the model pressure (MP), wherein the filling pulse is terminated when the model pressure (MP) exceeds a predetermined pressure threshold (MPₙₒₘ) that is produced according to the relation
MPₙₒₘ=MP_{Base}+k_{P2}*λ_{F}+k_{D2}*\dot{λ}_{F}
wherein;
MPₙₒₘ—requested nominal pressure
MP_{Base}—invariable base portion
λ_{F}—filtered wheel slip
\dot{λ}_{F}—filtered wheel slip acceleration
k_{P2}—proportional amplification factor
k_{D2}—differential amplification factor.

11. Method as claimed in claim 7, for a brake system with a high pressure accumulator, from which pressure fluid is introduced into the brake system during a traction slip control operation, further including the step of:
using the filling pulse or the nominal pressure (EPₙₒₘ) as a reference input for the control of the wheel pressure variation during a traction slip control operation.

12. Method as claimed in claim 11, further including the step of:
defining the reaching or exceeding of a pressure threshold as an event-responsive preset value, where the reference input or nominal pressure (EPₙₒₘ₂) and model pressure (MP) are identical.
